(19) United States
(12) Patent Application Publication
(10) Pub. No.: US 2008/0181534 A1
(43) Pub. Date: Jul. 31, 2008

(54) IMAGE PROCESSING METHOD, IMAGE PROCESSING APPARATUS, IMAGE READING APPARATUS, IMAGE FORMING APPARATUS AND RECORDING MEDIUM

(76) Inventors: Masanori Toyoda, Osaka (JP); Masakazu Ohira, Shiki-gun (JP)

Correspondence Address: BIRCH STEWART KOLASCH & BIRCH, PO BOX 747, FALLS CHURCH, VA, 22040-0747, US

(21) Appl. No.: 11/958,188

(22) Filed: Dec. 17, 2007

(30) Foreign Application Priority Data
Dec. 18, 2006 (JP) 2006-340467
Dec. 6, 2007 (JP) 2007-314986

(51) Int. Cl. G06K 9/36

(52) U.S. Cl. 382/284

(57) ABSTRACT

A document matching process section contains: features calculating section for extracting a plurality of connected components from input document images and calculating the centroids of the connected components and consequently determining the feature points; a features calculating section for calculating features of the document image from the distance between the calculated feature points; and a vote processing section for voting for a similar image in accordance with the calculated features, and uses the functions of this document matching process section and extracts the feature point from each of the two images and then correlates between the extracted feature points and consequently joins the images.

### CROSS-REFERENCE OF RELATED APPLICATION

This non-provisional application claims priority under 35 U.S.C. §119(a) on Patent Applications No. 2006-340467 and No. 2007-314986 filed in Japan on Dec. 18, 2006 and Dec. 6, 2007 respectively the entire contents of which are hereby incorporated by reference

### BACKGROUND

1. Technical Field

This application relates to: an image processing method of joining two images, and an image processing apparatus, an image reading apparatus, an image forming apparatus, and a recording medium.

2. Description of the Related Art

Conventionally, in an image forming apparatus such as a copier and the like, there is a case that a plurality of input images are partially overlapped and joined each other to consequently form one image and then carry out the image formation for the joined image. For this reason, as an image processing apparatus that is applied to a copier for copying the image of a document onto a recording medium, there is a type in which in a case of copying the image of the document larger than the scanner size equal to the maximal size that can be read by an image reading section, after a plurality of reading processes are performed on each of a plurality of partial images in which the image of the document is partially overlapped and divided, the plurality of read partial images are joined each other and restored to the image of the original document, and the image of the restored document is adjusted to the size of the recording radium and then outputted.

An image processing apparatus disclosed in Japanese Patent Application Laid Open No. 4-314263 performs a binarize process on each of a plurality of input images and carries out an extracting process for an edge portion in a binary image and compares the respective input images after the binary process and the edge extracting process in accordance with a pattern matching method and then joins the two input images to each other so that the portions where the features of the edge portions are coincident are overlapped

However, in the configuration disclosed in Japanese Patent Application Laid Open No. 4-314263, the images after the binarize process and the edge extracting process are defined as the feature data of the respective input images, and the comparison is carried out in accordance with the pattern matching method. However, this configuration is implicitly assumed such that the document which is read a plurality of times is not rotated. Thus, this has a problem that, when the pattern matching is performed on the actual two images, the coincident point cannot be accurately detected.

### SUMMARY

This application is proposed in view of such circumstances. It is therefore an object of the present application to provide an image processing method that is designed to: extract a plurality of connected components in which pixels are connected from each of two images; calculate features of each image in accordance with the feature points included in the extracted connected components; compare the calculated features and consequently correlates between the feature points; use information of the positions of the correlated feature points and calculate a transform matrix for representing a coordinate transform between the two images; and use the calculated transform matrix and transform one image and consequently join the images, and even if the input two images are inclined together, the correlation between the feature points can be accurately performed, thereby executing the image joining at a high precision, and an image processing apparatus, an image reading apparatus, an image forming apparatus, a computer program and a recording medium.

Also, another object of this application is to provide an image processing apparatus that can improve the precision of the transform matrix (the precision of the image synthesis) by selecting the feature point to be used, when calculating the transform matrix.

Moreover, another object of this application is to provide the image processing apparatus, which correlates the joined image data, the features, the index representing the document, and the tag information representing the joined image and stores and can extract the joined image data by using the original document without again executing the joining operation of the image.

An image processing method of inputting two images having regions to be overlapped with each other and joining the inputted two images in said region according to the present application comprises the steps of: extracting a plurality of connected components in which pixels are connected from each of said two images; extracting feature points included in each connected component thus extracted; calculating features of each image respectively based on the extracted feature points; correlating the extracted feature points of one image with those of the other image by comparing the calculated features of each image; calculating a transform matrix for transforming a coordinate system of one image into a coordinate system of the other image by using information of positions of the correlated feature points; and joining said two images by using the calculated transform matrix and transforming said one image.

An image processing apparatus for inputting two images having regions to be overlapped with each other and joining the inputted two images in said region according to the present application comprising: a connected component extracting section for extracting a plurality of connected component in which pixels are connected from each of said two images; a feature point extracting section for extracting feature points included in each connected component thus extracted; a features calculating section for calculating features of each image respectively based on the extracted feature points; and an image join processing section capable of performing operations of; correlating the extracted feature points of one image with those of the other image by comparing the calculated features of each image; calculating a transform matrix for transforming a coordinate system of one image into a coordinate system of the other image by using information of positions of the correlated feature points; and joining said two images by using the calculated transform matrix and transforming said one image.

The image processing apparatus according to the present application is characterized in that said feature point extracting section removes feature points which become impediments when calculating the transform matrix, from said extracted feature points.

The image processing apparatus according to the present application is characterized in further comprising a controlling section for storing the joined image as associating with features extracted from said two images, first identification information for identifying each of said two images and second identification information indicating the joined image.

The image processing apparatus according to the present application is characterized in further comprising an document matching section for matching the inputted image with reference images; wherein said document matching section contains said connected component extracting section, the feature point extracting section and the features calculating section and compares the calculated features with features of a pre-stored reference image and then votes for the reference image having coincident features.

The image processing apparatus according to the present application is characterized in that said feature point extracting section calculates a centroid of the connected component extracted by said connected component extracting section and defines the calculated centroid as the feature point of the connected component.

The image processing apparatus according to the present application is characterized in that said features are invariant parameters with respect to a geometrical change including a rotation, a parallel movement, a scaling of said image.

The image processing apparatus according to the present application is characterized in that said features calculating section calculates a hash value in accordance with a hash function that is formulated by using a distance between the feature points extracted from one image, and defines the calculated hash value as the features of said image.

The image processing apparatus according to the present application is characterized in that the region to be joined is preliminary determined for each image.

An image reading apparatus according to the present application is characterized in comprising a scanner platen on which a document is placed; an image reading section for reading an image from the document placed on the scanner platen; and the image processing apparatus; wherein the two images read by the image reading section are joined by said image processing apparatus.

The image reading apparatus according to the present application is characterized in that a region to be joined is set on said scanner platen.

An image forming apparatus according to the present application is characterized in comprising: the image processing apparatus; and an image forming section for forming the image, which is obtained by joining two images in the image processing apparatus, on a sheet.

The image forming apparatus according to the present application is characterized in comprising: a scanner platen on which a document is placed; and an image reading section for reading an image from the document placed on the scanner platen, wherein a region to be joined is set on said scanner platen.

A recording medium according to the present application is characterized in storing thereon a computer program executable to perform the steps of: extracting a plurality of connected components in which pixels are connected from each of two images having regions to be overlapped to each other; extracting feature points included in each connected component thus extracted; calculating features of each image respectively based on the extracted feature points; correlating the extracted feature points of one image with those of the other image by comparing the calculated features of each image; calculating a transform matrix for transforming a coordinate system of one image into a coordinate system of the other image by using information of positions of the correlated feature points; and joining said two images by using the calculated transform matrix and transforming said one image.

This application uses the feature points extracted from each of the two images and calculates the features of each image, and compares the calculated features and consequently performs the correlation between the feature points, and uses the coordinates of the correlated feature points and determines the transform matrix representing the coordinate conversion. The conventional image joining uses the pattern matching in which the various feature points are employed. However, in this application, the features invariable against the geometrical change including the rotation, parallel movement, the scaling of the image is used to correlates between the feature points. Thus, even if the inclination and the like are generated in the two images, the correlation between the feature points can be accurately performed, thereby joining the two images at the high precision.

In this application, the selected feature points are used to join the images. Thus, the precision of the image joining can be improved.

In this application, in accordance with the information that is correlated and stored in a storing means, the joined image data can be read, thereby extracting the joined image data by using the original document without again executing the joining operation of the images.

In this application, an image matching section contains the connected component extracting section, the feature point extracting section and the features calculating section and then executes the process for comparing the calculated features and the features of the pre-stored storage image and votes for the storage image having the coincident features. Thus, using a part of the functions of the image matching section can correlates between the feature points extracted from the two images, and using information of the positions of the correlated feature points can join the images. Also, since a part of the functions of the image matching section is used, the circuit configuration that is added to join the images can be minimized as necessary.

In this application, the centroid of the extracted connected component is calculated, and the calculated centroid is defined as the feature point. Thus, the feature point of any image can be extracted, and the features can be calculated at a high speed and a high precision.

In this application, the parameter invariable against the geometrical change including the rotation, parallel movement, the scaling of the image is calculated as the features. Thus, when the image of the joining target is reversed in upper and lower directions and scanned, the precision of the image joining can be kept at a constant level or a higher level than the constant level.

In this application, a hash value is calculated in accordance with a hash function that is formulated by using the distance between the feature points. Thus, it is possible to calculate the invariant based on the geometrical arrangement of the feature points.

In this application, the region to be joined is preset, which can reduce the processing time.

In this application, the image joining can be performed on the image that is read by a scanning apparatus, a multi-function printer and the like.

In this application, the region to be joined is set for a document stand. Thus, the position at which the document is placed can be easily specified.

This application can be applied to a printer apparatus, a multi-function printer and the like, and the image thus joined can be formed on a sheet.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram explaining an internal configuration of an image processing system that contains an image processing apparatus according to this embodiment;

FIG. 2 is a block diagram showing an internal configuration of a document matching process section;

FIG. 3 is a block diagram showing a configuration of a feature point calculating section;

FIGS. 4A and 4B are diagrammatic views showing an extraction examples of the feature point;

FIG. 5 is a block diagram showing a configuration of a features calculating section;

FIG. 6 is an explanation view explaining a current feature point and surrounding feature points;

FIGS. 7A to 7C are explanation views explaining a calculation example of invariant with respect to the current feature point P3;

FIGS. 8A to 8C are explanation views explaining a calculation example of the invariants when the current feature point is assumed to be the current feature point P4;

FIGS. 9A to 9D are explanation views explaining the other calculation example of the invariants when the current feature points are assumed to be P3;

FIGS. 10A to 10D are explanation views explaining the other calculation example of the invariants when the current feature points are assumed to be P4;

FIGS. 11A and 11B are conceptual views showing one example of the hash table;

FIG. 12 is a graph showing one example of a vote result;

FIG. 13 is an explanation view explaining the correlation between feature points extracted from two images;

FIG. 14 is a flowchart explaining the procedure of a image joining process based on the image processing system according to the first embodiment;

FIGS. 15A and 15B are explanation views explaining a procedure for reading a document;

FIGS. 16A and 16B are views showing a correlation relation between features (hash value) and indexes of the feature points;

FIGS. 17A and 17B are views showing a correlation relation between the indexes and coordinates of the feature points;

FIG. 18 is a diagrammatic view showing a setting example of a region to be overlapped

FIG. 19 is a diagrammatic view showing one example of the feature points extracted from each of two images on which a correlation is performed;

FIGS. 20A and 20B are explanation views explaining prepared histograms;

FIG. 21 is a block diagram explaining the internal configuration of a image processing system that contains a image processing apparatus according to this embodiment;

FIG. 22 is a block diagram showing an internal configuration of the image synthesis processing section;

FIG. 23 is a flowchart explaining the procedure of an image joining process based on the image processing system according to the second embodiment;

FIG. 24 is a flowchart explaining the procedure of the image joining process based on the image processing system according to the second embodiment;

FIGS. 25A and 25B are diagrammatic views showing one example of the image inputted by the image processing apparatus;

FIGS. 26A and 26B are diagrammatic views showing the manner in which a first image region and a second image region are set;

FIG. 27 is a block diagram showing an internal configuration of an image processing apparatus in which a computer program according to this embodiment is installed;

FIG. 28 is a diagrammatic view showing an entire system of a network system according to this embodiment;

FIG. 29 is a block diagram showing the internal configuration of MFP and the server;

FIG. 30 is a diagrammatic view showing one example of a operation panel; and

FIG. 31 is a diagrammatic view showing one example of a screen that is displayed when an image joining mode is selected from the operation panel.

### DETAILED DESCRIPTION

An embodiment of the present invention will be specifically described below by using drawings.

### First Embodiment

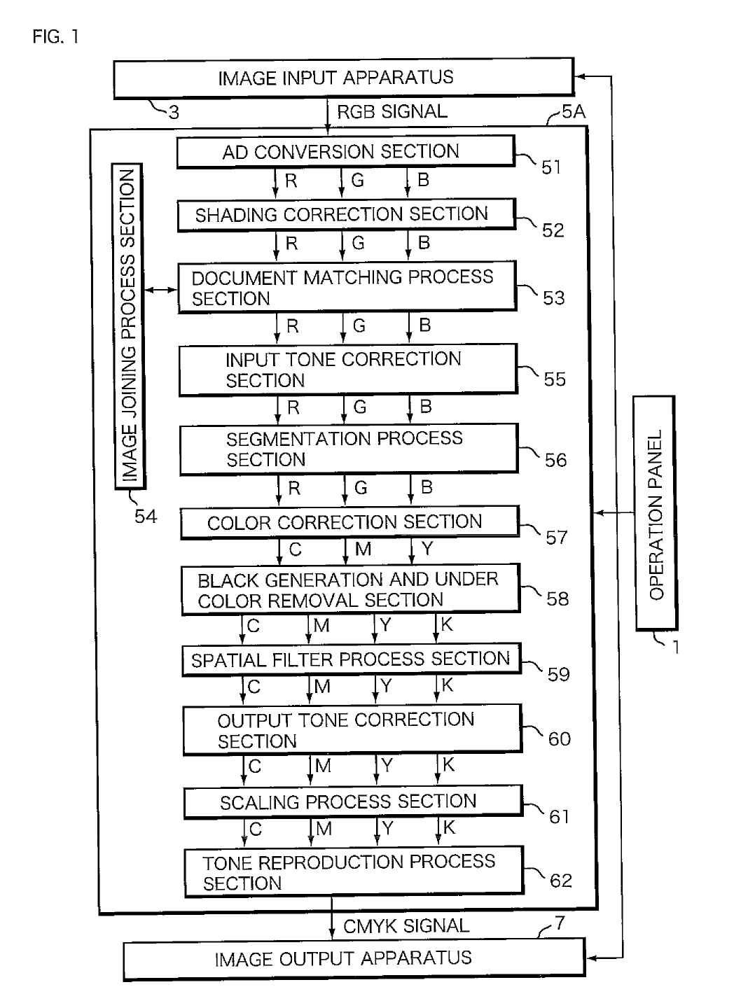

FIG. 1 is a block diagram explaining the internal configuration of the image processing system that contains an image processing apparatus according to this embodiment. The image processing system according to the first embodiment contains an operation panel 1, an image input apparatus 3, an image processing apparatus 5A and an image output apparatus 7.

The operation panel 1 is provided with a liquid crystal display, various switches and the like. The operation panel 1 displays information to be reported to a user and accepts various selection operations to be executed by the user, and the like.

The image input apparatus 3 is the reading means for optically reading the image of a document and contains a light source for emitting a light to the document to be read and an image sensor such as CCD (Charge Coupled Device) and the like. In the image input apparatus 3, the reflection light image from the document set at a predetermined read position is focused on the image sensor, and an analog electric signal of RGB (R: Red, G: Green and B: Blue) is outputted. The analog electric signal outputted by the image input apparatus 3 is inputted to the image processing apparatus 5A.

The image processing apparatus 5A, after converting the analog electric signal outputted by the image input apparatus 3 into a digital electric signal, carries out a proper image processing and outputs the obtained image data to the image output apparatus 7. Here, the internal configuration, the operation and the like of the image processing apparatus 5A will be described later in detail.

The image output apparatus 7 is the means for forming the image on the sheet, such as a paper, an OHP film or the like, in accordance with the image signal outputted by the image processing apparatus 5A. For this reason, the image output apparatus 7 contains: an electrifier for electrifying a photoconductor drum to a predetermined potential; a laser writing unit for emitting a laser light on the basis of the image data received from outside and then forming an electrostatic latent image on the photoconductor drum; a developer for supplying a toner to the electrostatic latent image formed on the photoconductor drum surface and developing it; a transcriber for transcribing the toner image formed on the photoconductor drum surface onto the paper (not shown); and the like. Then, in accordance with an electron photo method of using the laser writing unit, the image desired by the user is formed on the paper. Here, other than the formation of the image in accordance with the electron photo method of using the laser writing unit, the configuration for forming the image based on an ink jet method, a thermally transcribing method, a sublimation method and the like may be used.

The internal configuration of the image processing apparatus 5A will be described below. An AD conversion section 51 converts an analog signal of RGB inputted from the image input apparatus 3 into a digital signal. A shading correction section 52 performs a process, which removes the various distortions generated in the illuminating system, image focusing system and image sensing system in the image input apparatus 3, on the RGB signal of the digital type outputted by the AD conversion section 51. The RGB signal on which the shading correction is performed is outputted to a document matching process section 53.

The document matching process section 53 determines whether or not the image inputted through the image input apparatus 3 is similar to a reference image (hereafter, referred to as a stored format), and when the input image is determined as being similar to the reference image, determines whether or not the input image is the image written to the stored format. When it is determined that the input image is the image written to the stored format, the document matching process section 53 extracts the region corresponding to the writing and correlates the image in the extracted region to the stored format and then stores it therein.

An image joining process section 54, when joining the two images inputted through the image input apparatus 3, uses a part of the functions of the document matching process section 53, extracts the feature points common to both of the images, correlates the extracted feature points each other, determines a transform matrix for transforming the coordinate system of one image into the coordinate system of the other image, uses the determined transform matrix, and transform the one image and then carries out the image joining process.

An input tone correction section 55 carries out an image quality adjusting process, such as a removal of a page background density, a contrast and the like. A segmentation process section 56 carries out a process for separating each pixel in the input image into any one of a text component, a halftone component and a photograph component (a continuous tone component), through the RGB signal. The segmentation process section 56 outputs a segmentation class signal for indicating the component to which the pixel belongs, in accordance with the separation result, to a black generation and under color removal section 58, a spatial filter process section 59 and a tone reproduction process section 62 at the later stage, and also outputs the input RGB signal in its original state to a color correction section 57 at the later stage.

The color correction section 57 carries out a process for removing the color impurity based on the spectral characteristics of CMY color materials, which include useless absorption components, in order to faithfully reproduce the colors. The RGB signal after the color correction is outputted to the black generation and under color removal section 58 at the later stage. The black generation and under color removal section 58 carries out a black generation process for generating a black (K) signal from the CMY 3-color signal after the color correction and a process for generating a new CMY signal in which the K-signal obtained in the black generation is subtracted from the original CMY signal. By this process, the CMY 3-color signal is converted into a CMYK 4-color signal.

As one example of the black generation process, there is a method of black generating by a skeleton black. In this method, when the input/output characteristic of a skeleton curve is represented by y=f(x), the input data is defined as C, M, Y, the output data is defined as C′, M′, Y′, K′, and a UCR rate (UCR: Under Color Removal) is defined as α (0<α<1), the black generation base color removing process is represented by the following equation.

K′=f{min(C,M,Y)}

C′=C−αK′

M′=M−αK′

Y′=Y−αK′

The spatial filter process section 59 performs a spatial filter process that uses a digital filter based on the segmentation class signal, on the image data of the CMYK signal received from the black generation and under color removal section 58, and carries out a process for correction a space frequency characteristic and consequently avoids the blur occurrence or graininess degradation in the output image.

For example, in the component area that is separated into the text by the segmentation process section 56, in order to especially improve the reproduction performance of a achromatic text or chromatic text, the edge enhancement process in the spatial filter process, which is carried out by the spatial filter process section 59, increases the emphasis degree of high frequencies. Simultaneously, the tone reproduction process section 62 selects the binarizing process or multi-level dithering process on the screen of the high resolution suitable for the reproduction of the high frequencies. Also, on the component that is separated into the halftone component by the segmentation process section 56, the spatial filter process section 59 performs a low pass filter process for removing the input halftone components. Then, an output tone correction section 60 executes an output tone correction process for converting a signal, such as a concentration signal or the like, into a halftone screen ratio, which is a characteristic value of the image output apparatus 7. After that, the tone reproduction process section 62 executes a tone reproducing process for finally separating the image into pixels and reproducibly processing the respective tone. Also, the binarizing process or multi-level dithering process on the screen in which importance is attached to the tone reproduction performance is performed on the component that is separated into the photograph by the segmentation process section 56. Also, a scaling process section 61 executes a scaling process, as necessary, prior to the execution of the tone reproducing process.

The image data on which the foregoing respective processes are performed is once stored in a storing means (not shown) and read out at a predetermined timing and then outputted to the image output apparatus 7.

This embodiment is characterized in that the image joining process section 54 uses a part of the functions of the document matching process section 53 and joins the images. The detail of the document matching process section 53 will be described below.

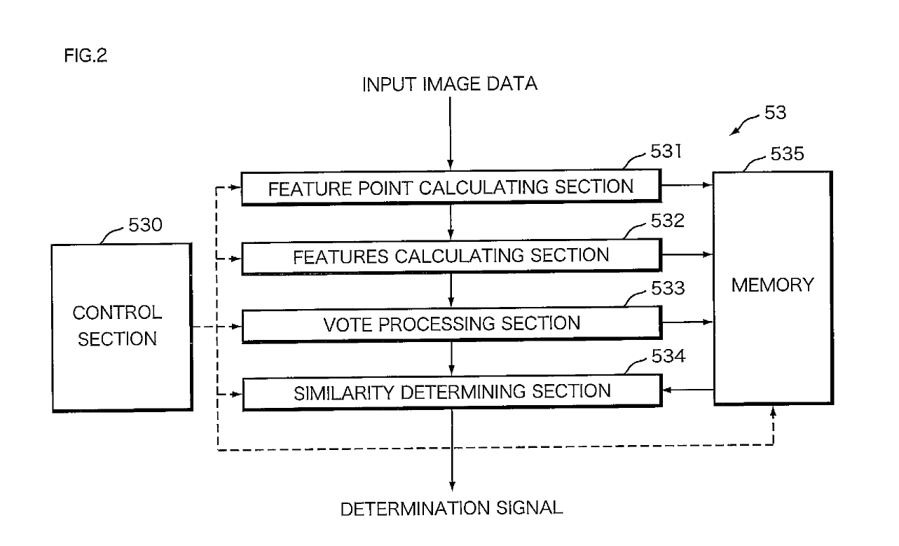

FIG. 2 is a block diagram showing the internal configuration of the document matching process section 53. The document matching process section 53 contains a control section 530, a feature point calculating section 531, a features calculating section 532, a vote processing section 533, a similarity determining section 534 and a memory 535.

The control section 530 is, for example, CPU and controls the respective sections in the foregoing hardware. The feature point calculating section 531 extracts connected components from character strings, a ruled lines and the like, which are included in the input image, and then calculates the centroids of the connected components as the feature points. The features calculating section 532 uses the feature points calculated by the feature point calculating section 531 and calculates the features (hash value) that is invariant against a rotation, a scaling. The vote processing section 533 uses the features calculated by the features calculating section 532 and votes for the stored format pre-stored in the memory 535. The similarity determining section 534 uses the vote result and judges the similarity between the input image and the stored format.

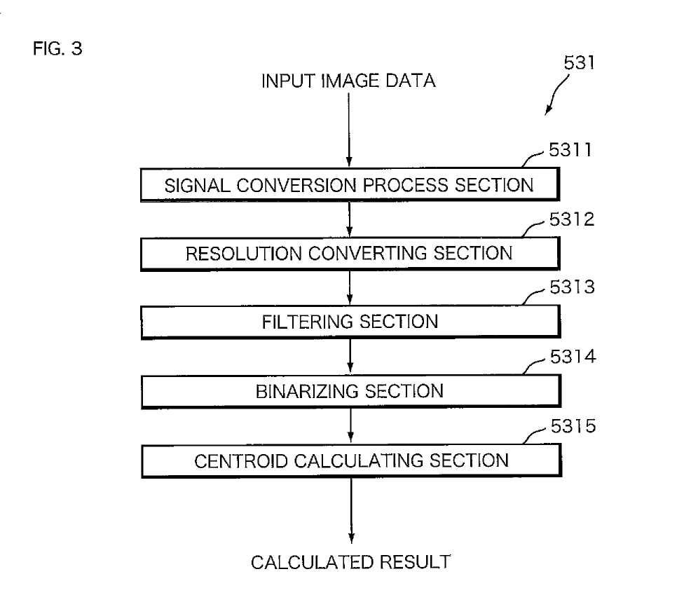

FIG. 3 is a block diagram showing the configuration of the feature point calculating section 531. The feature point calculating section 531 contains a signal conversion processing section 5311, a resolution converting section 5312, a filtering section 5313, a binarization processing section 5314 and a centroid calculating section 5315.

The signal conversion processing section 5311 is the processing section which, when the input image data is the colored image, makes it achromatic and converts into a lightness signal or luminance signal. For example, the luminance signal is determined from the following equation.

Yj=0.30Rj+0.59Gj+0.11Bj

Here, Yj indicates a luminance value of each pixel, and Rj, Gj and Bj indicate the respective color components of the respective pixels. Also, without any use of this method, the RGB signal may be converted into CIE1976L*a*b* signals (CIE: Commission International de l'Eclairage, L: Lightness, a*, b*: Chromaticity)

The resolution converting section 5312 is the processing section that, when in the image input apparatus 3, the scaling process is optically performed on the input image data, again performs a scaling process so that it has the predetermined resolution. Also, in the resolution converting section 5312, in order to reduce the processing amount at the later stage, this is also used as the resolution conversion for reducing the resolution as compared with the resolution read in the same magnification in the image input apparatus 3. For example, the image data read at 600 dpi (dot per inch) is converted into 300 dpi.

The filtering section 5313 is the processing section that is used to absorb the fact that the space frequency performance of the image input unit is different for each model. In the image signal outputted by CCD, there is the deterioration such as the blur of the image or the like that is caused by the integration effect and the scanning irregularity and the like, which results from the optical parts such as a lens, a mirror and the like, the aperture opening degree of the light receiving surface of CCD, the transfer efficiency, the afterimage, and the physical scanning. The filtering section 5313 executes a process for performing a suitable filtering process (emphasizing process) and consequently recovering the halation caused by the deterioration in MTF. Also, this is used in order to suppress the high frequency components unnecessary for the process at the later stage. That is, a mixture filter is used to carry out the emphasizing and smoothing processes.

The binarization processing section 5314 is the processing section for preparing the binary image data suitable for calculating the centroid from the achromatic image data. The centroid calculating section 5315 determines the centroid of the connected components from the binary data and defines this as the feature point and then outputs to the features calculating section 532. As the method of calculating the centroid, a conventional method can be used. That is, each pixel is labeled in accordance with the binary information of the binary image, and the connected component connected by the pixels on which the same label is assigned is specified, thereby calculating the centroid of the specified connected component as the feature point.

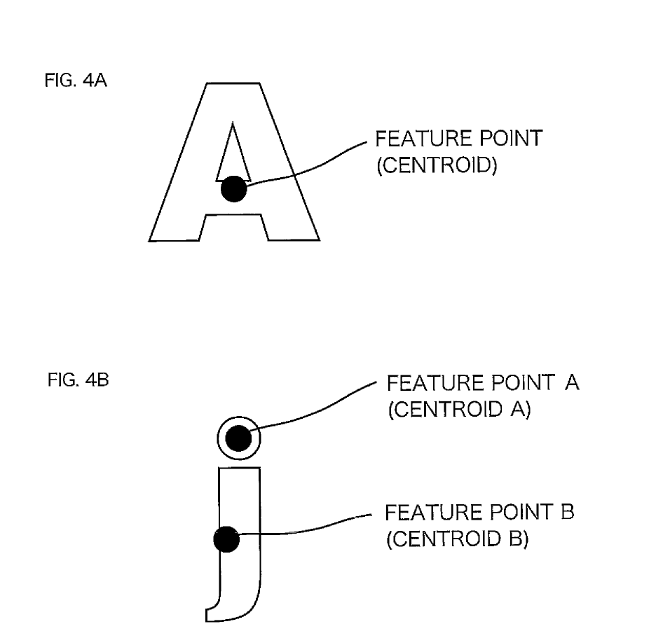

FIGS. 4A and 4B are diagrammatic views showing the extraction examples of the feature point. FIG. 4A is the example in which a character “A” is specified as the connected component by the foregoing method, and the point indicated by a black round in FIG. 4A indicates the manner calculated as the feature point (centroid). FIG. 4B is the example in which the connected component is similarly extracted from a character “j”, and the manner in which the connected component is divided into the two components and specified is indicated. In this case, the feature point (centroid) is calculated from each component. Thus, the two feature points (the feature point A and the feature point B) are calculated from one character.

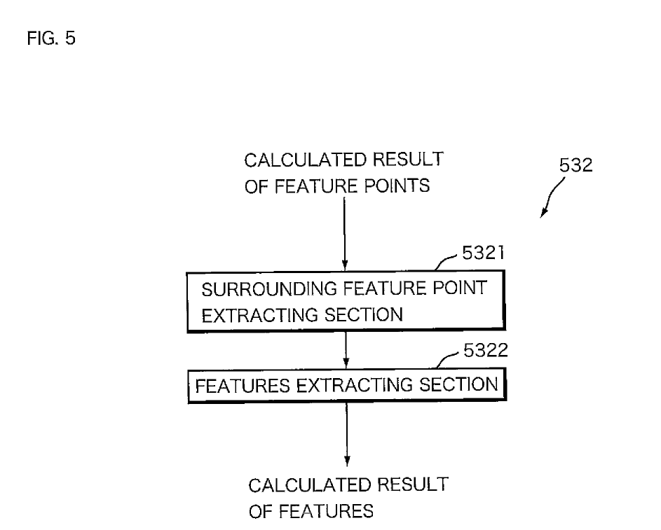

The calculating method of the features (feature vectors) will be described below. FIG. 5 is a block diagram showing the configuration of the features calculating section 532. The features calculating section 532 contains a surrounding feature point extracting section 5321 and a features extracting section 5322. The surrounding feature point extracting section 5321 selects any one of the plurality of feature points selected by the feature point calculating section 531, as a current feature point and selects the 4 feature points as surrounding feature points, in an order of increasing the distance from the current feature point. The features extracting section 5322 calculates the hash value (features) in accordance with the distances of the 4 surrounding feature points with respect to the current feature point.

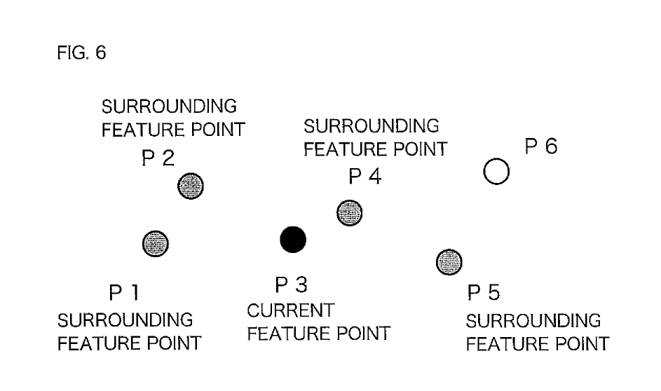

FIG. 6 is an explanation view explaining the current feature point and the surrounding feature points. FIG. 6 shows the manner in which 6 feature points P1 to P6 are calculated by the feature point calculating section 531. At this time, when the features calculating section 532 selects the feature point P5 as the current feature point, the feature points P1, P2, P4 and P5 are selected as the surrounding feature points. The features calculating section 532 uses the selected current feature point (P3) and the surrounding feature points (P1, P2, P4 and P5) and calculates the invariant which remain unchanged during the tilting, movement, or rotation of the input image and determines the features of the input image from the calculated invariants.

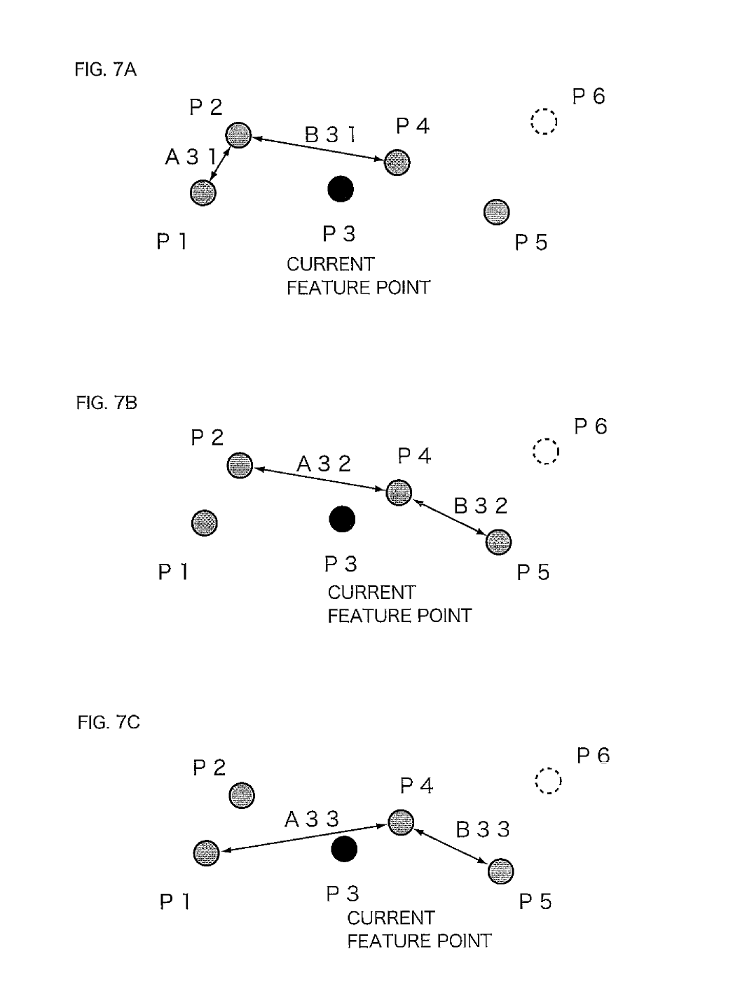

FIGS. 7A to 7C are explanation views explaining the calculation examples of the invariants with respect to the current feature point P3. The distances between the current feature point P3 and the surrounding feature points P1, P2, P4 and P5 are used to define an invariant H3j on the basis of H3j=A3j/B3j. Here, j has the values of j=1, 2 and 3, and A3j and B3j indicate the distances between the feature points, respectively. The distance between the feature points is calculated in accordance with the coordinate value of each surrounding feature point. That is, the three invariants are calculated. Then, the value of the invariant 1 is A31/B31 (refer to FIG. 7A), the value of the invariant H32 is A32/B32 (refer to FIG. 7B), and the value of the invariant H33 is A33/B33 (refer to FIG. 7C). The invariants H3j remain unchanged when the document is rotated, moved, or tilted during the reading processing, hence allowing the judgment of the similarity between the images at the succeeding step to be carried out at higher accuracy.

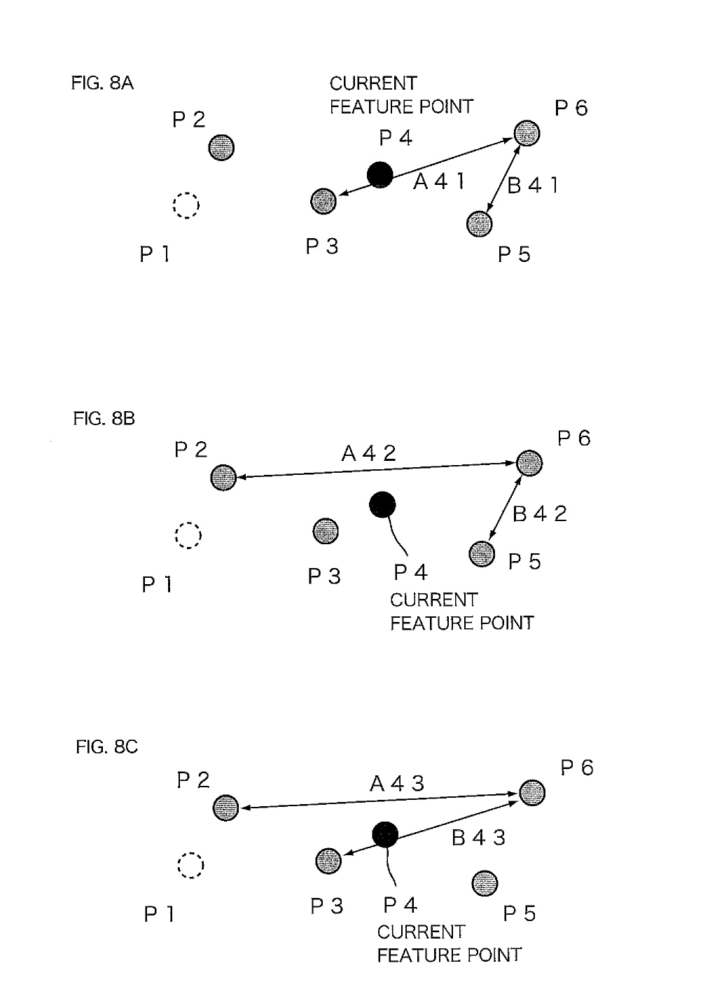

FIGS. 8A to 8C are explanation views explaining the calculation examples of the invariant when the current feature point is assumed to be the current feature point P4. The features calculating section 532 selects the current feature points P2, P3, P6 and P6 as the surrounding feature points. At this time, the invariants H4j (j=1, 2 and 3) can be calculated on the basis of H4j=A4j/B4j, similarly to the foregoing calculation. That is, the value of the invariant H41 is A41/B41 (refer to FIG. 8A), the value of the invariant H42 is A42/B42 (refer to FIG. 8B), and the value of the invariant H43 is A43/B43 (refer to FIG. 8C).

The case when the other feature points P1, P2, P5 and P6 are selected as the current feature points is similar. Then, the features calculating section 532 changes the current feature point in turn, and calculates the invariants Hij (i=1, 2 to 6, and j=1, 2 and 3) when the respective feature points P1, P2 to P6 are selected.

Then, the features calculating section 532 calculates the features (hash value) Hi from the invariants determined with the different current feature points. When the current feature point is assumed to be the feature point Pi, the hash value Hi is represented by the Hi=(Hi1×10^{2+Hi2×}10¹+Hi3×10⁰)/E. Here, i is a natural number and indicates the number of the feature points, and E is the constant that is determined in accordance with the set remainder level. For example, in a case of E=10, the remainder has the value between 0 and 9, which implies the obtainable range of the calculated hash value.

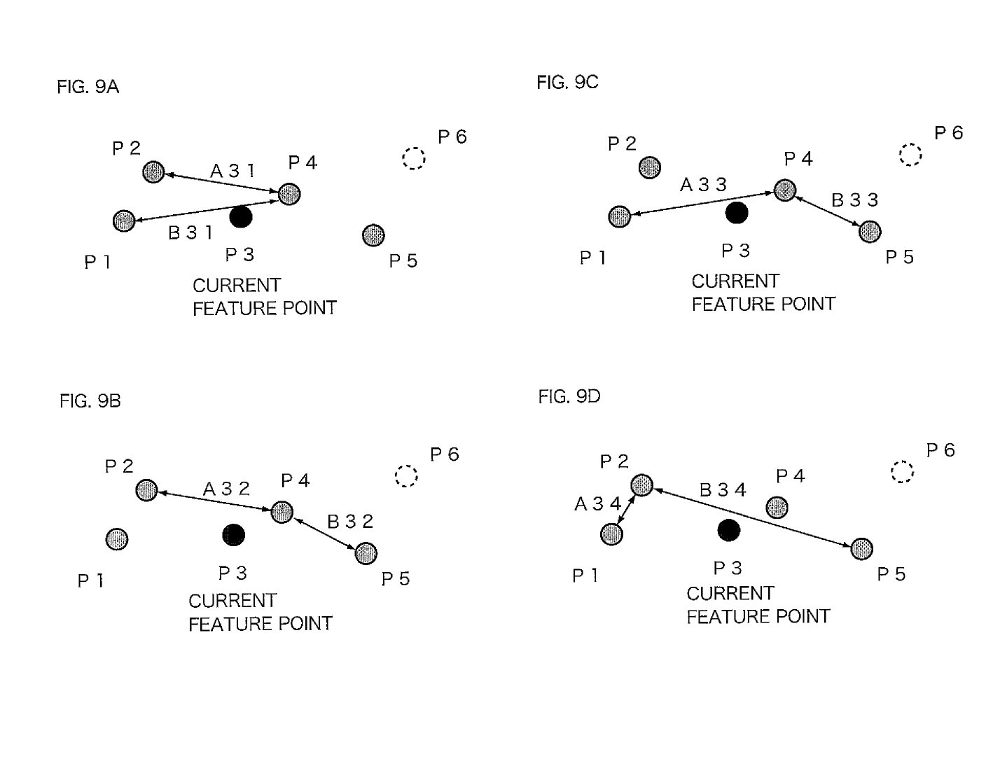

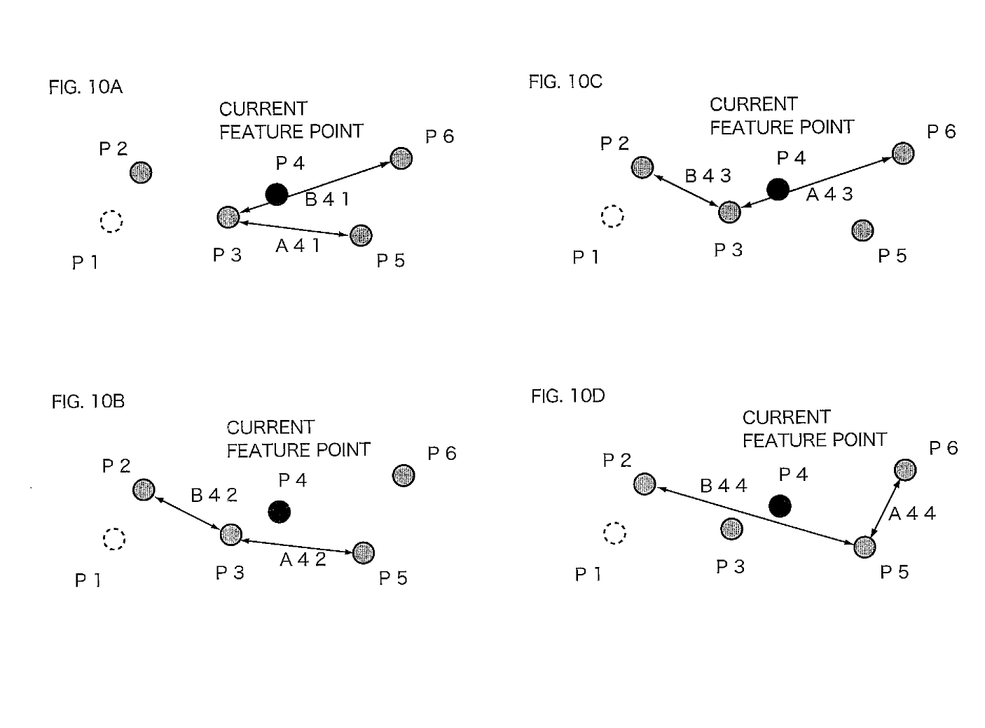

FIGS. 9A to 9D and FIGS. 10A to 10D are explanation views explaining the other calculation examples of the invariants when the current feature points are assumed to be P3 and P4, respectively. As the method of calculating the invariant with respect to the current feature point, for example, as shown in FIGS. 9A to 9D, four combinations are selected from the four surrounding feature points P1, P2, P4 and P5 of the current feature point P3, and the invariant H3j (j=1, 2, 3 and 4) may be calculated on the basis of H3j=A3j/B 3j, similarly to the foregoing calculation. Also, when the current feature point is assumed to be P4, four combinations are similarly selected from the four surrounding feature points P2, P3, P5 and P6 of the current feature point P4 (refer to FIGS. 10A to 10D), and the invariant H4j (j=1, 2, 3 and 4) may be calculated on the basis of H4j=A4j/B4j. In this case, the hash value is calculated by Hi=(Hi1×10²+Hi2×10²+Hi3×10¹+Hi4×10⁰)/E.

Here, the hash value as the features is indicated as one example, and it is not limited thereto. Then, a different hash function can be used. Also, in the foregoing example, the four points are designed to be selected as the feature points. However, the number is not limited to 4. For example, the six points may be extracted. In this case, as for the six respective methods in which the five points are extracted from the six feature points and then the five points are extracted, the three points are extracted from the five points, and the invariant is determined. Then, the hash value may be calculated.

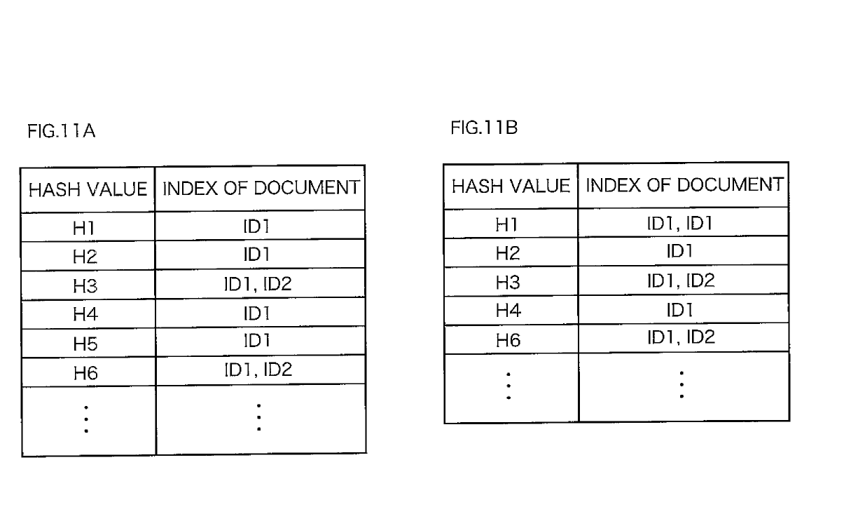

The features calculating section 532 calculates the features (hash value) for each connected component as mentioned above. The vote processing section 533 retrieves a hash table in accordance with the hash value calculated by the features calculating section 532 and votes for the document of a registered index. FIGS. 11A and 11B are conceptual views showing one example of the hash table. The hash table is constituted by the respective columns composed of the hash values and the indexes indicative of the stored formats. That is, as shown in FIG. 11A, the index representing the stored format is registered correspondingly to the features representing the feature of the connected component. For example, when the calculated hash value is “H1”, the vote processing section 533 votes for the stored format having the index of “ID1”. Also, when the calculated hash value is “H3”, the vote processing section 533 votes for the two kinds of the stored formats (namely, the stored formats having the indexes of “ID2”, “ID3”. The case in which the calculated hash value is a different value is also similar. Here, when the hash values are equal (H1=H5), as shown in FIG. 11B, the two entries on the hash table can be integrated into a single entry.

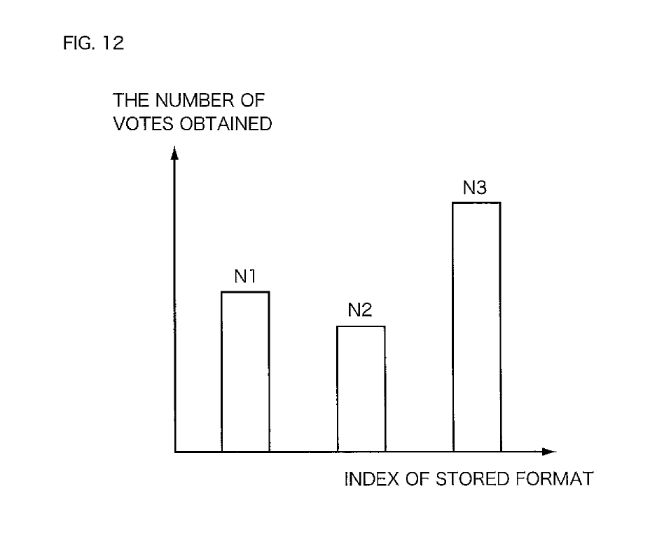

FIG. 12 is a graph showing one example of the vote result. The horizontal axis indicates the kind of the stored format, and the vertical axis indicates the number of obtained votes. The example shown in FIG. 12 indicates the manner in which the votes are cast for the three kinds of the stored formats (“N1” to “N3”). The vote result in which the votes are accumulatively added is outputted to the similarity determining section 534.

The similarity determining section 534 determines the similarity of the image in accordance with the vote result received from the vote processing section 533 and reports the determination result to the control section 530. The similarity determining section 534 compares the number of the votes (the number of the obtained votes) received from the vote processing section 533 with a predetermined threshold, and when the number of the votes is equal to or greater than the threshold, determines that the input image is similar to the stored format. The similarity determining section 534, when the number of the votes received from the vote processing section 533 is smaller than the threshold, determines that the similar document does not exist, and then reports the result to the control section 530.

Here, the foregoing determination method is one example. As a different method, for example, the number of the votes is divided by the maximum number of the obtained votes for each document (the number of the feature points determined for each document and the like). Then, the normalization is executed. After that, the similarity determination may be executed.

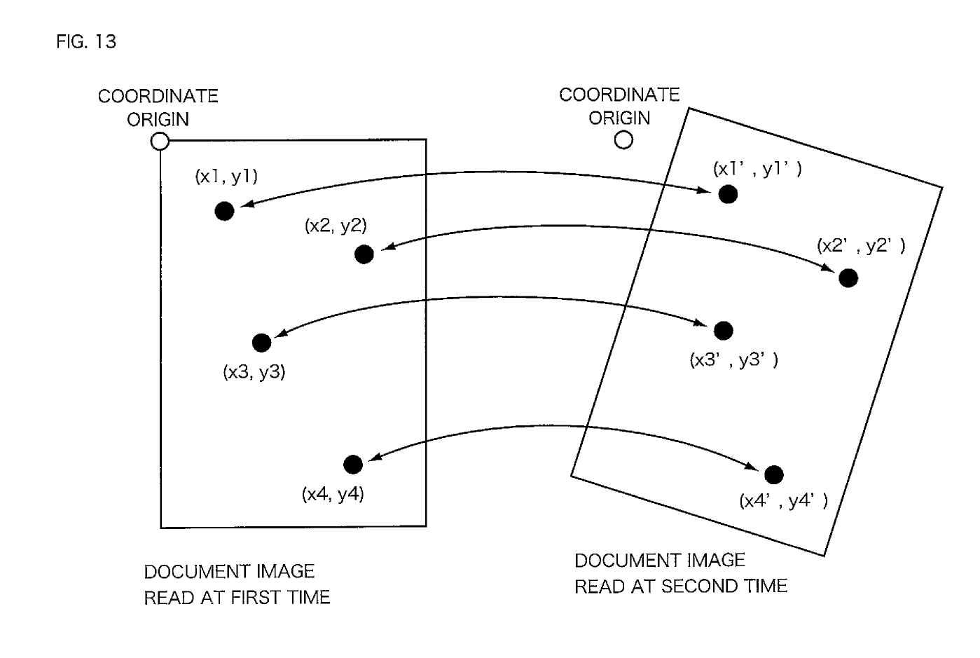

The image joining process section 54, when a part of the functions of the document matching process section 53 is used to join the two document images, firstly correlates between the coordinates of the feature points of the document image read at the first time and the coordinates of the feature points of the document image read at the second time. FIG. 13 is an explanation view explaining the correlation between the feature points extracted from the two images. The example shown in FIG. 13 indicates the manners that the four feature points having the coordinates (x1, y1), (x2, y2), (x3, y3) and (x4, y4) are extracted from the document image read at the first time and that the respective feature points are correlated to the four feature points having the coordinates (x1′, y1′), (x2′, y2′), (x3′, y3′) and (x4′, y4′) extracted from the document image read at the second time, respectively.

When a matrix prepared by using the coordinates of the feature points of the document image read at the first time is assumed to be Pout and a matrix prepared by using the coordinates of the feature points of the document image read at the second time is assumed to be Pin, the equation for transforming the coordinate system of one document image into the coordinate system of the other document image can be represented below by using a transform matrix A.

Pout=Pin×A Equation 1

where,

$$Pin = ( \begin{matrix}x 1 & y 1 & 1 \\ x 2 & y 2 & 1 \\ x 3 & y 3 & 1 \\ x 4 & y 4 & 1\end{matrix} ) , Pout = ( \begin{matrix}x {1}^{′} & y {1}^{′} & 1 \\ x {2}^{′} & y {2}^{′} & 1 \\ x {3}^{′} & y {3}^{′} & 1 \\ x {4}^{′} & y {4}^{′} & 1\end{matrix} ) , A = ( \begin{matrix}a & b & c \\ d & e & f \\ g & h & i\end{matrix} )$$

The matrix Pin is not a square matrix. Thus, the transform matrix A can be determined by multiplying both the sides by a transpose matrix Pin^{T} and further multiplying by the inverse matrix of Pin^{T}Pin.

A=(Pin^{T}Oout)⁻¹Pin^{T}Pout Equation 2

Thus, the equation for transforming the coordinates (x, y) on one image into the coordinate system on the other image can be represented below by using the transform matrix A.

(x′,y′,1)=(x,y,1)×A Equation 3

The image joining process section 54 transforms the coordinate on one image by the equation 3 and consequently joins the image.

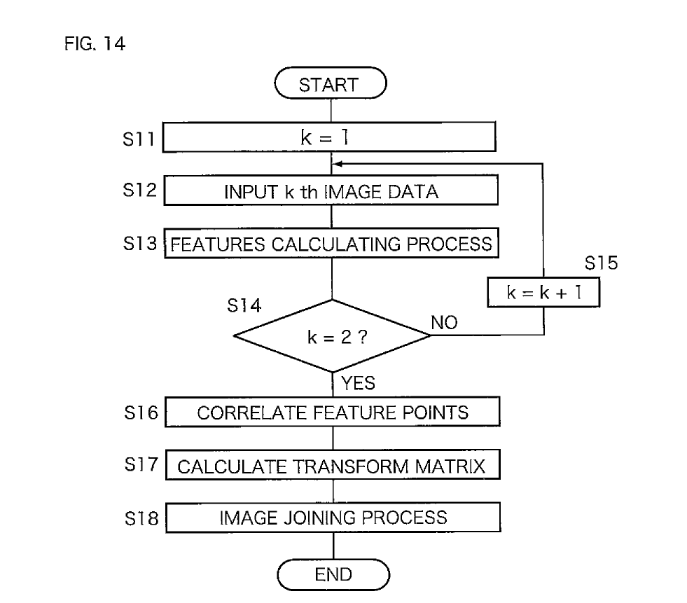

The specific processing procedure of the image joining will be described below. FIG. 14 is a flowchart explaining the procedure of the image joining process based on the image processing system according to the first embodiment. The image processing apparatus 5A firstly sets a number k of the input of the image data to 1 (Step S11) and inputs the image data at a k-th time (Step S12).

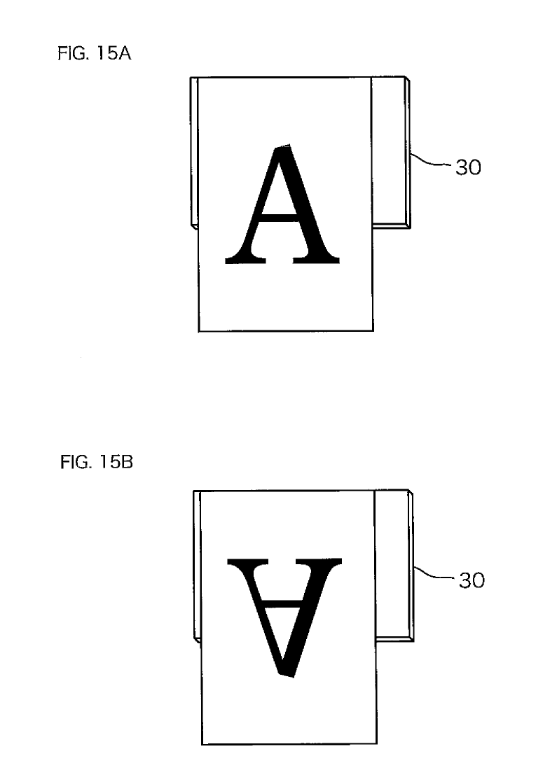

FIGS. 15A and 15B are explanation views explaining the procedure for reading the document. In this embodiment, the document (for example, the document of an A3 size) of the size exceeding the size (for example, an A3 size) of a platen 30, on which the document is placed, together with several overlapped regions is scanned two times. FIG. 15A shows the manner in which the upper region of the document is scanned, and FIG. 15B shows the manner in which, while a part of the upper region is overlapped, the lower region of the document is scanned. That is, the image is inputted so as to exhibit the regions overlapped with each other.

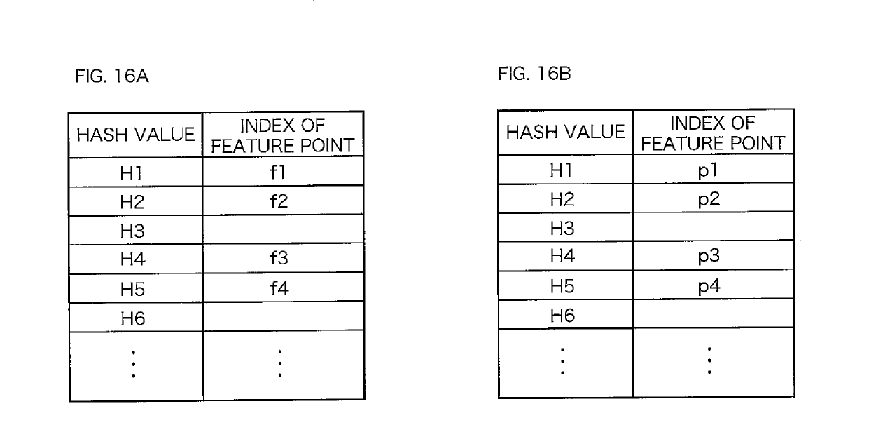

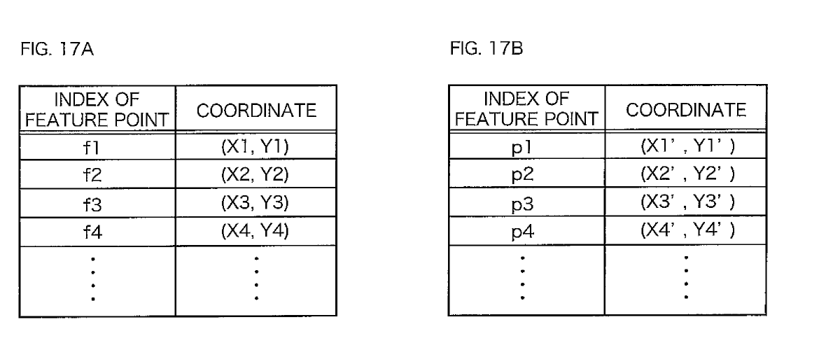

Next, the feature point calculating section 531 and features calculating section 532 in the document matching process section 53 are used to execute the features calculating process (Step S13). At this time, the document matching process section 53 stores the index of the feature point corresponding to the hash value calculated as features and also stores the coordinates of the feature points which are correlated to each index. FIGS. 16A and 163 are views showing the correlation relation between the features (hash value) and the index of the feature point, and FIGS. 17A and 17B are views showing the correlation relation between the index of the feature point and the coordinates. Such correlation relations are stored in, for example, the memory 535 in the document matching process section 53.

Next, the image processing apparatus 5A determines whether or not the captured image data is that of the second time (namely, whether or not k=2) (Step S14), and when this is not that of the second time (S14: NO), the value of k is incremented by 1 (Step S15), and the process is shifted to the step S12.

When the inputted image is that of the second time (S14: YES), the correlation of the feature point is executed (Step S16). When the correlation relations between the hash values calculated from the images inputted at the first and second times and the index of the feature point are as shown in FIGS. 16A and 16B, respectively, and when the correlation relations between the index representing the feature point and the coordinates are as shown in FIGS. 17A and 17B, respectively, feature points f1, f2, f3 and f4 calculated from one image are known to be correlated to feature points p1, p2, p3 and p4 extracted from the other image, respectively.

When those feature points are used to join the two images, the image joining process section 54 uses the two sets or more of the corresponding feature points to calculate the transform matrix A (Step S17). Since the calculated transform matrix A is used, any coordinates (x, y) on the image of the first time are transformed into the coordinates (x′, y′) on the image of the second time. Consequently, when the document of the first time has the inclination, in accordance with this transform matrix A, the coordinate conversion is executed correspondingly to the coordinate system of the scanned image of the second time, and the entirely continuous images can be joined (Step S18).

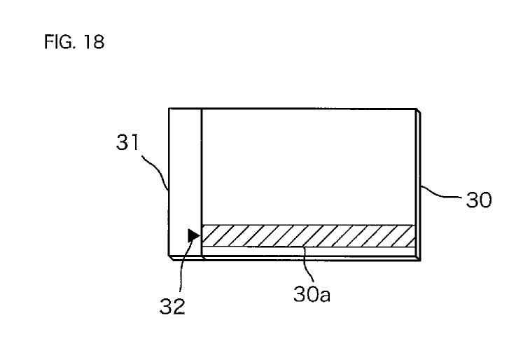

Here, the calculations of the feature point and the features may be performed on the entire image, or the region to be overlapped may be preset to calculate the feature point and the features only inside the set region. FIG. 18 is a diagrammatic view showing the set example of the overlapped region. In the example shown in FIG. 18, in order to clearly show the overlapped region, an indication plate 31 is placed on the side of a platen 30. The indication plate 31 has an indicator 32, and a region 30a on the platen specified by the indicator 32 is set as the overlapped region. The series of the processes may be performed on only the region having a set width by performing the first and second scannings correspondingly to this region and then preparing the input image data.

When the region to be overlapped is not set and when the correlations between the feature points f1, f2, f3 and f4 calculated from one image and the feature points p1, p2, p3 and p4 extracted from the other image are executed, the feature point may be selected. Since the overlapped documents are read, in most of the feature points, those of the overlapped region are correlated. However, depending on a condition, there may be a possibility that the hash value of the feature point in the overlapped region is coincident with the hash value of the region that is not overlapped. When the data of the coordinates of the feature point except the overlapped region is included, there may be a fear that the accuracy of the transform matrix is decreased. Thus, only the feature point inside the overlapped region is used.

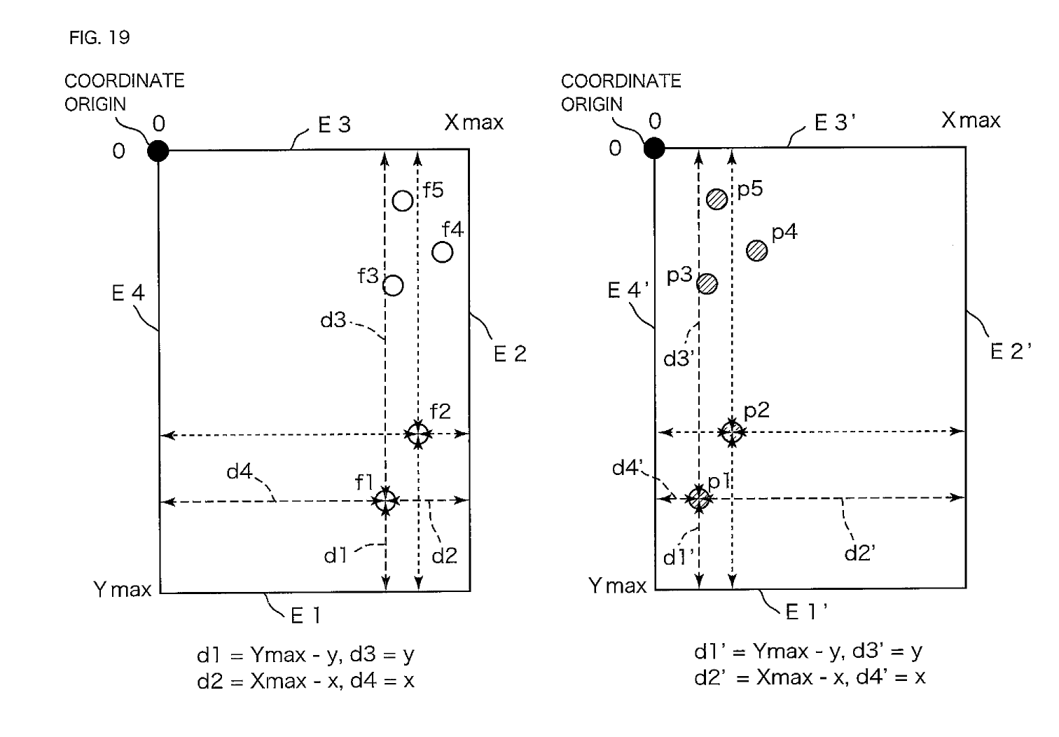

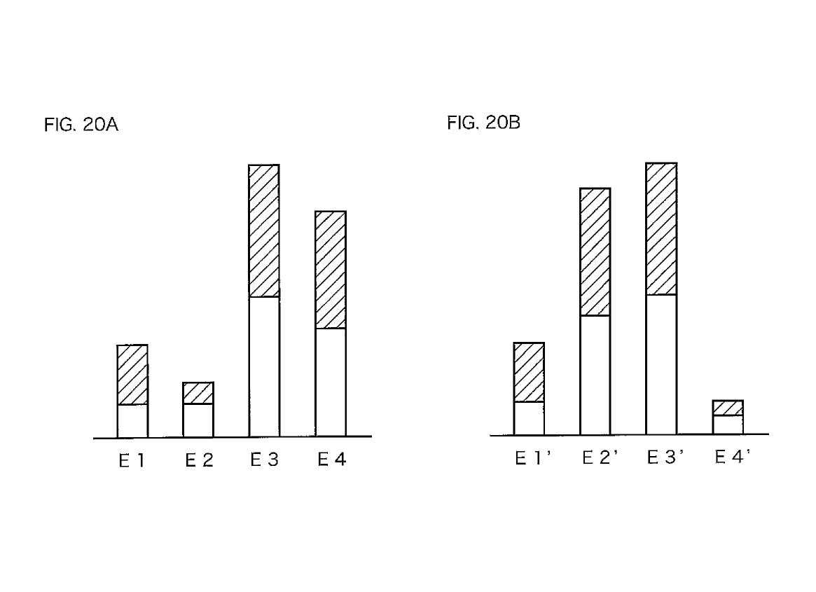

FIG. 19 is a diagrammatic view showing one example of the feature point extracted from each of the two images on which the correlation setting is performed. For example, the feature points in which the features are coincident are extracted from both of the images. Then, histograms in which the distances from four sides E1, E2, E3 and E4, and E1′, E2′, E3′ and E4′ of the documents are added are prepared for the extracted feature points f1, f2, f3, f4, . . . and p1, p2, p3, p4, . . . . Then, which side of the document close to the region from which each feature point is extracted (which region is read overlapped) is judged. FIGS. 20A and 20B are explanation views explaining the prepared histograms. In the foregoing histograms, the side from which the feature point is extracted has the smallest histogram (the accumulation value of the distances between the respective points and the side). Thus, using this feature can judge the region from which the feature point is extracted. (FIGS. 20A and 20B indicate the example in which the coordinates of the two feature points are added). Then, selecting the feature point located within a predetermined range (for example, 500 at the coordinate position of the feature point) from the specified side can remove the unnecessary feature points and determine the transform matrix. Also, the region (side) where the feature point exists is automatically judged. Thus, the user, when reading the document, can read the document without considering the orientation of the document.

Here, when a digital copier or a multi-function printer is used to carry out the image joining process, for example, the mode of the image joining process is selected from the operation panel 1. The setting of the mode is recognized by the control section 530. Then, the functions of the document matching process section 53 are used to carry out the image joining process. The image data obtained by the image joining process is reduced to the value predetermined by the scaling process section 61 (or the value set by the user) and sent through the tone reproduction process section 62 to the image output apparatus 7.

### Second Embodiment

In the first embodiment, the document matching process section 53 is used to carry out the image joining process. However, the configuration for inclusion of the functions of the document matching process into the image joining may be employed. In this embodiment, the configuration of the image processing apparatus in which the document matching process is assembled into the image joining process is described.

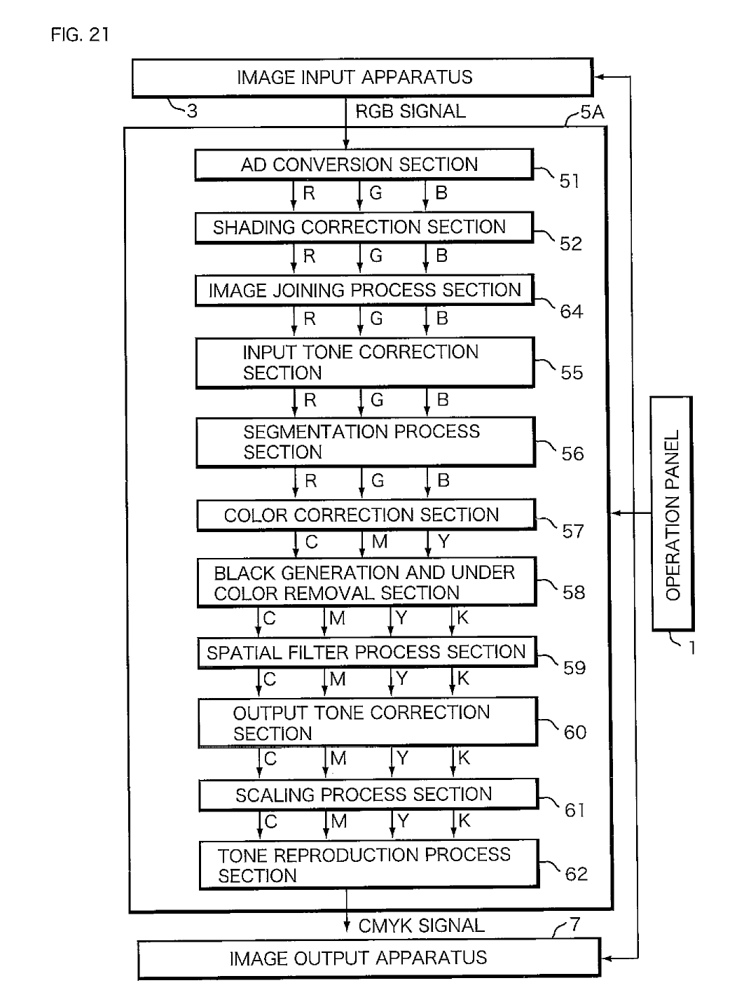

FIG. 21 is a block diagram explaining the internal configuration of the image processing system that contains the image processing apparatus according to this embodiment. The image processing system according to the second embodiment contains the operation panel 1, the image input apparatus 3, an image processing apparatus 5B and the image output apparatus 7. Among them, the configurations except the image processing apparatus 5B are similar to those of the first embodiment.

The image processing apparatus 5B contains the AD conversion section 51, the shading correction section 52, an image synthesis processing section 64, the input tone correction section 55 the segmentation process section 56, the color correction section 57, the black generation and under color removal section 58, the spatial filter process section 59, the output tone correction section 60, the scaling process section 61 and the tone reproduction process section 62. Among them, the configurations except the image synthesis processing section 64 are perfectly similar to those of the first embodiment.

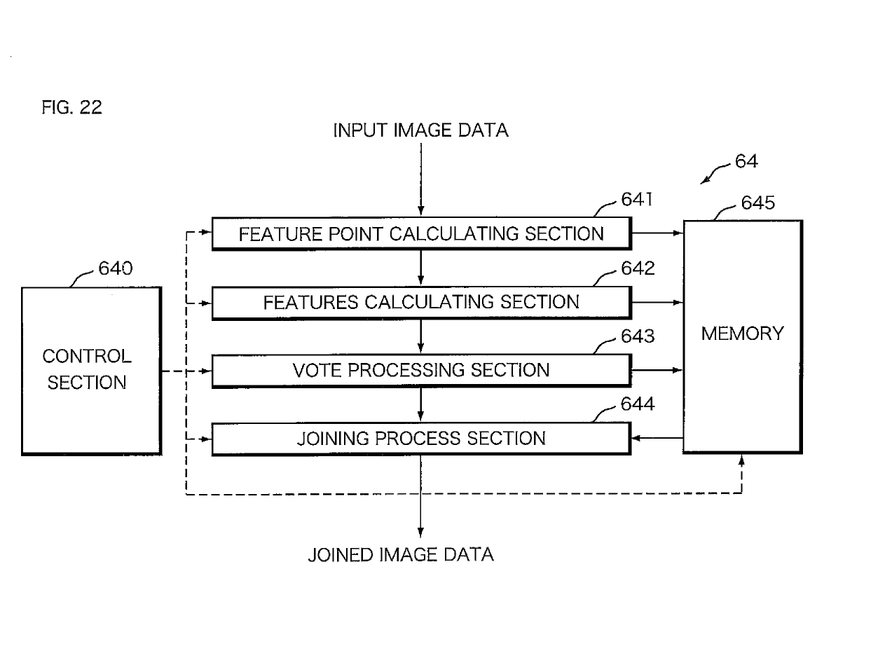

FIG. 22 is a block diagram showing the internal configuration of the image joining processing section 64. The image joining processing section 64 contains a control section 640, a feature point calculating section 641, a features calculating section 642, a vote processing section 643, a joining process section 644 and a data storing section 645.

The control section 640 is, for example, CPU and controls the respective sections of the foregoing hardware. The feature point calculating section 641 extracts the connected components from the character string, the ruled line and the like, which are included in the input image and then calculates the centroid of the connected components as the feature points. The features calculating section 642 uses the feature points calculated by the feature point calculating section 641 and calculates the features (hash value) that is invariant against a rotation, a scaling. The vote processing section 643 uses the features calculated by the features calculating section 642 and votes for the stored format pre-stored in the memory 645. The joining process section 644 uses the vote result executed by the vote processing section 643 and consequently determines the correlation relation between the feature points extracted from the two images and then calculates the transform matrix established between the images. Then, in accordance with the calculated transform matrix, one image is transformed into the coordinate system of the other image, and the image joining process is executed.

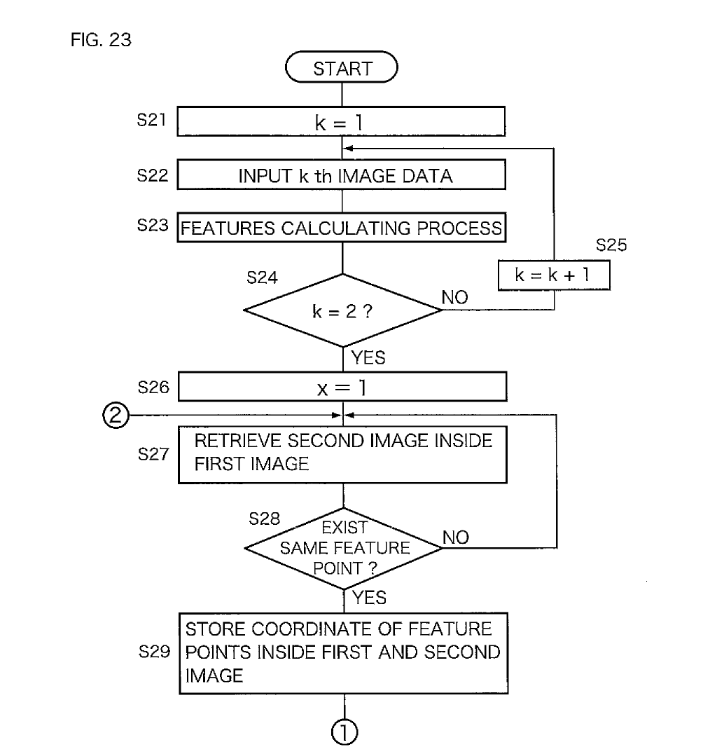

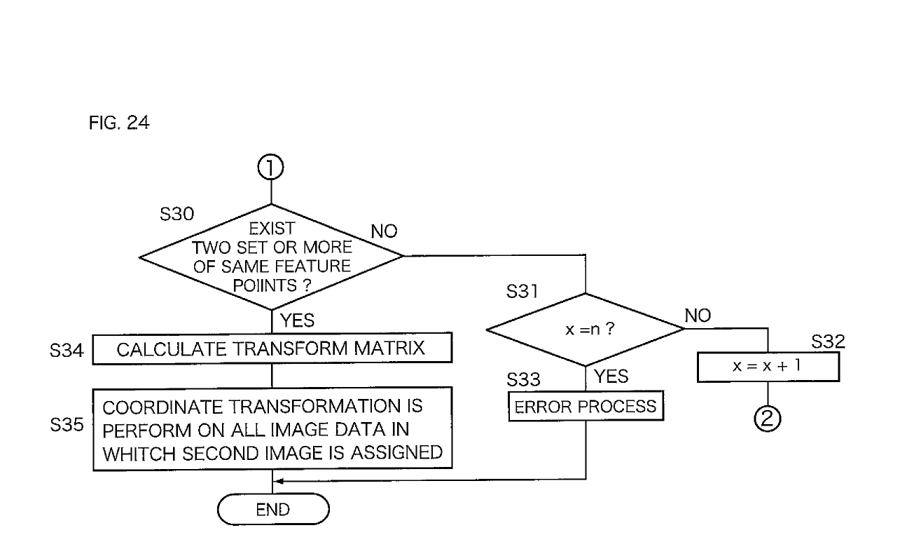

FIGS. 23 and 24 are flowcharts explaining the procedure of the image joining process based on the image processing system according to the second embodiment. The image processing apparatus 5B firstly sets the number k of the input of the image data to 1 (Step S21) and inputs the image data at the k-th time (Step S22). Then, the feature point calculating section 641 and the features calculating section 642 in the image joining process section 64 are used to carry out the features calculating process (Step S23).

Next, the image processing apparatus 5B determines whether or not the inputted image data is that of the second time (namely, whether or not k=2) (Step S24), and when this is not that of the second time (S24: NO), the value of k is incremented by 1 (Step S15), and the process is shifted to the step S22.

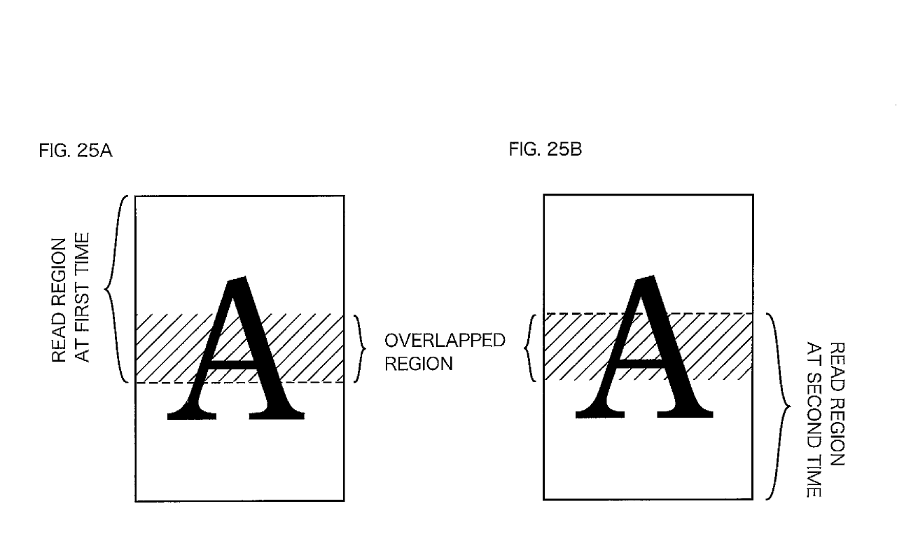

FIGS. 25A and 25B are diagrammatic views showing one example of the image inputted by the image processing apparatus 5B. The size of the document read by the image input apparatus 3 is slightly larger than the size of the platen 30. In this embodiment, for example, the reading is divided into the two readings, and the readings are performed on the upper and lower regions of the document. At this time, the readings are performed such that the overlapped region including the common image is formed in the upper and lower regions (refer to FIGS. 25A and 25B).

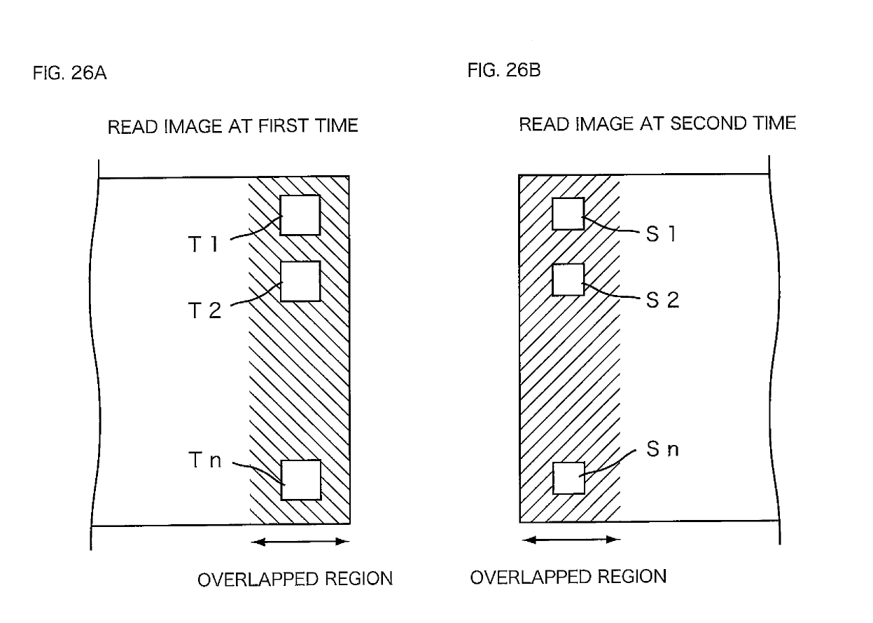

In this embodiment) n (n is an integer of 2 or more) first image regions are set for the read image of the first time, and n second image regions are set for the read image of the second time. Then, the correlations between the feature points inside the first image region and the feature points inside the second image region is executed. FIGS. 26A and 26B are diagrammatic views showing the manner in which the first image region and the second image region are set. That is, they indicate the manner in which n first image regions T1, T2 to Tn are set for the read image of the first time shown in FIGS. 26A and n second image regions S1, S2 to Sn are set for the read image of the second time shown in FIG. 26B.

The explanation is returned to the flowchart shown in FIG. 23, and the correlations between the feature points and the procedure of the image joining process will be described below. When the inputted image data is that of the second time (S24: YES), the image joining process section 64 sets an index x of the first image region Tx and the second image region Sx to 1 (Step S26). Then, the second image is inside the first image region Tx is retrieved (Step S27), and whether or not the same feature point exists in both the regions is determined (Step S28). When it is determined that the same feature point does not exist (S28: NO), the process is returned to the step S27.

When it is determined that the same feature point exists (S28: YES), the image joining process section 64 stores the coordinates of the feature points inside the first image region Tx and the second image region Sx (Step S29).

Next, in order to determine whether or not the transform matrix can be calculated, the image joining process section 64 determines whether or not two sets or more of the same feature points are obtained (Step S30). When it is determined that the two sets or more of the same feature points are not obtained (S30: NO), it is determines whether or not the index x arrives at the set number n of the first image region Tx and the second image region Sx (Step S31). When it is determined that the index x does not arrive at the set number n (S31: NO), the image joining process section 64 increments the value of the index x by 1 (Step S32) and returns the process to the step S27. That is, when the two sets or more of the same feature points are not obtained, the transform matrix A cannot be determined. Thus, the correlation between the feature points is also tried for the remaining first image region Tx and second image region Sx. On the other hand, when it is determined that under the situation in which the two sets or more of the same feature points are not obtained, the index x arrives at the set number n (S31: YES), an error process is carried out (Step S33), and the process based on this flowchart is terminated. The error process reports, for example, the fact that the image joining process cannot be completed, to the user.

When it is determined that the two sets or more of the same feature points are obtained at the step S30 (Step S30: YES), this calculates the transform matrix A explained in the first embodiment by using the two sets or more of the corresponding feature points (Step S34). Then, the coordinate transformation is performed on all the image data of the images in which the second image region is assigned (Step S35), and it is joined as the entirely continuous image.

Here, in this embodiment, the first image region is set for the read image read at the first time, and the second image region is set for the read image read at the second time. However, as described in the first embodiment, the configuration may be employed in which the correlation relation between the feature points in the overlapped regions read without setting of those image regions is determined, and the coordinate transformation is carried out, and the images are joined.

### Third Embodiment

The first and second embodiments are designed such that the respective processes are attained by using the hardware. However, they may be attained by using the process of the software.

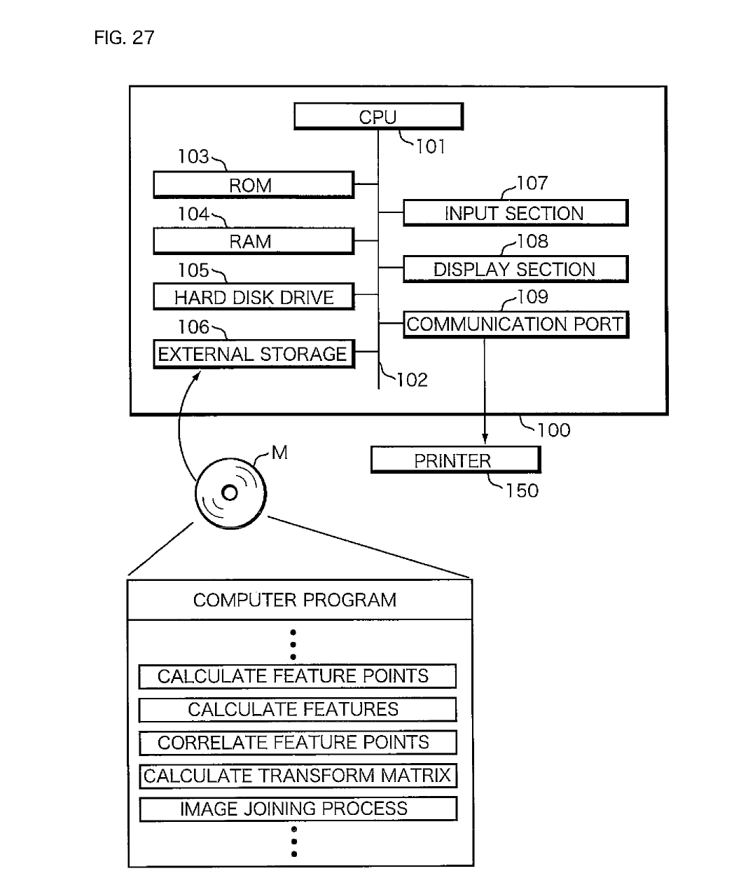

FIG. 27 is a block diagram showing the internal configuration of the image processing apparatus in which a computer program according to this embodiment is installed. In FIG. 27, 100 indicates the image processing apparatus according to this embodiment, and this is specifically a personal computer, a workstation or the like. An image processing apparatus 100 contains a CPU 101. The hardware such as a ROM 103, a RAM 104, a hard disk drive 105, an external storage 106, an input section 107, a display section 108, a communication port 109 and the like are connected through a bus 102 to the CPU 101. The CPU 101 controls the respective sections of the hardware, in accordance with a control program stored in advance in the ROM 103.

The RAM 104 is the volatile memory for transiently storing the various data that are generated during the execution of the program code of the control program, or the computer program according to this embodiment (an executable program, an intermediate code program, a source program). The hard disk drive 105 is the storage means having a magnetic recording medium and stores the program code of the computer program according to this embodiment and the like. The external storage 106 contains a reading unit for reading the program code from a recording medium M that records the program of the computer program according to this embodiment. As the recording medium M, FD (Flexible Disk), CD-ROM and the like can be used. The program code read by the external storage 106 is stored in the hard disk drive 105. The CPU 101 loads the program code according to this embodiment, which is stored in the hard disk drive 105, onto the RAM 104 and executes it. Consequently, the entire apparatus functions as the apparatus for attaining the image process as explained in the first embodiment, and correlates between the feature points in accordance with the features calculated from the two images, respectively, and the transform matrix for transforming the coordinate system of one image into the coordinate system of the other image is calculated, and the calculated transform matrix is used to join the two images.

The input section 107 works as an interface for inputting image data from the outside. For example, a color scanner apparatus and the like are connected to the input section 107. The display section 108 works as an interface for displaying image data of the processing target, image data during the image process, image data after the image process and the like. This may be configured such that the external displaying apparatus such as a liquid crystal display or the like is connected to the display section 108 to display image data, or the display section 108 itself contains the display apparatus to display image data. The communication port 109 is the interface to connect a printer 150 to the outside. When the image data after the image process is printed by the printer 150, the image processing apparatus 100 generates the print data that can be decoded by the printer 150 in accordance with the image data and transmits the generated print data to the printer 150.

Here, this embodiment is designed such that the various calculations are carried out by the CPU 101. However, this may be designed such that the dedicated chip for carrying out the calculations related to the picturing process is separately installed and the calculations are carried out in accordance with the instruction from the CPU 101.

Also, as the recording medium M for recording the computer program code according to this embodiment, in addition to the foregoing FD and CD-ROM, it is possible to use: the optical disc such as MO, MD, DVD and the like; the magnetic recording medium such as a hard disk drive and the like; a card type recording medium such as an TC card, a memory card, an optical card and the like; and the semiconductor memory such as a mask ROM, EPROM (Erasable Programmable Read Only Memory), EEPROM (Electrically Erasable Programmable Read Only Memory), the flash ROM and the like. Also, this has the system configuration in which the communication network including the Internet can be connected. Thus, the computer program code according to this embodiment may be downloaded from the communication network.

Also, the computer program according to this embodiment may be the type provided as a single application program, utility program or may be the type that is assembled in a different application program, utility program and provided as the function of the part of the program. For example, as its one type, the provision type assembled in a printer driver is considered. Here, this embodiment may be attained even in the type of the computer data signal embedded in a carrier wave in which the program code is embodied in an electronic transmission.

### Fourth Embodiment

In the first and second embodiments, the example of using the digital copier or the multi-function printer and carrying out the image joining process is explained. However, this may be attained by using the server connected in the network and sharing the process.

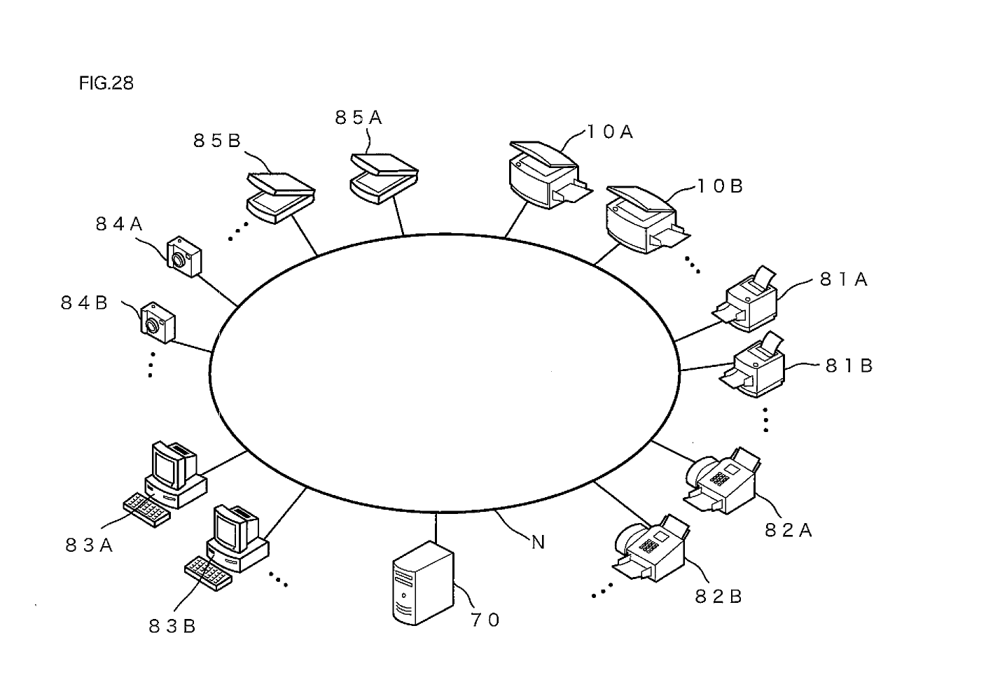

FIG. 28 is a diagrammatic view showing the entire system of the network system according to this embodiment. As shown in FIG. 28, in the network system according to this embodiment, a server 70, multi-function printers (MFP) 10A, 10B, . . . , printers 81A, 81B, . . . , facsimiles 82A, 82B, . . . , computers 83A, 83B, . . . digital cameras 84A, 84B, . . . , scanners 85A, 85B, . . . and the like are connected through a network N. The configuration of the system is not limited to the foregoing configuration. For example a plurality of servers 70 may be connected.

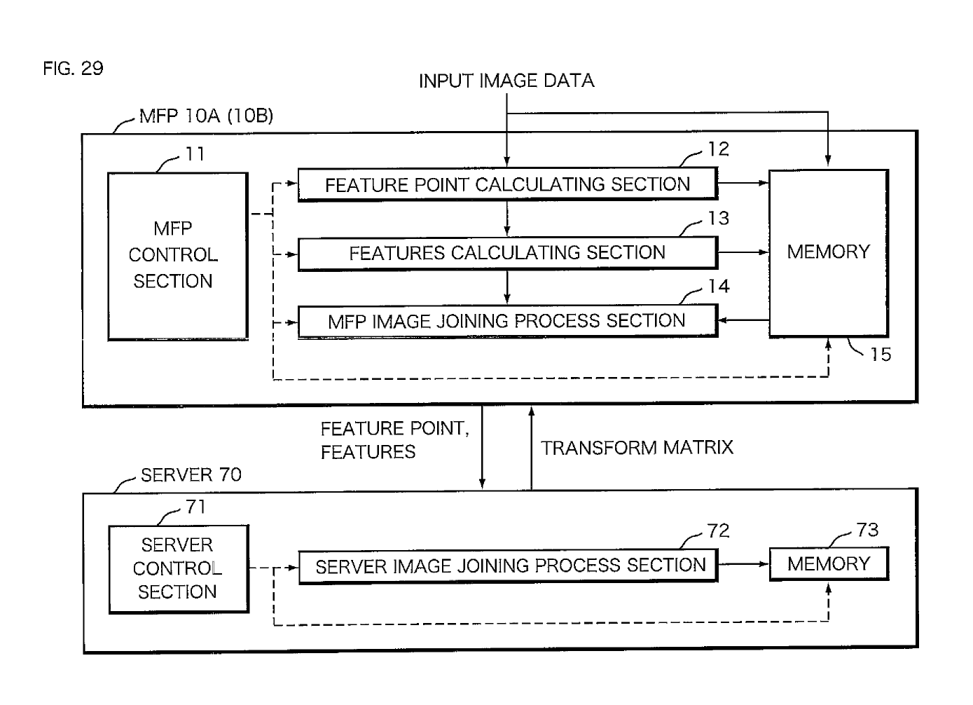

FIG. 29 is a block diagram showing the internal configuration of MFP 10A (10B) and the server 70. The MFP 10A (10B) contains: an MFP control section 11 for controlling the respective sections of the hardware inside the apparatus; a feature point calculating section 12 for calculating the feature points from the read document image; a features calculating section 13 for calculating the features of the document image in accordance with the calculated feature points; an MFP image joining process section 14 for carrying out the image joining process by using the calculated features; and a memory 15. The processes executed by the respective sections of the hardware are similar to the processes executed by the image processing apparatus 5A explained in the first embodiment. Thus, the explanations of their details are omitted.

The server 70 contains: a server control section 71 for controlling the respective sections of the hardware inside the apparatus; a server image joining process section 72 for carrying out the image joining process; and a memory 73. The server image joining process section 72 carries out the process for calculating the transform matrix in accordance with the data of the feature points and features that are calculated in the MFP 10A (10B).

For example, in the MFP 10A, the feature points and the features are calculated from the document image read at the first time and the document image read at the second time and sent to the server 70. Also, the read document image is once stored in the hard disk drive or the like. This may be compressed and stored as necessary. In the server 70, the data of the feature point is used to calculate the transform matrix, and the calculated result is sent to the MFP 10A. In the MFP 10A, when the transform matrix is received, the document image stored in the hard disk drive or the like is read (when it is compressed, a decoding process is performed thereon, and it is read) and the transform matrix is used to join the images.

### Fifth Embodiment

The joined image data, the index representing the original image data, the tag indicative of the joined image data, and the features (namely, the joined image data, the tag indicative of the joined image data, and the hash table) are stored in the server 70 (which may be the hard disk drive such as the MFP 10A and the like) and the like. Then, the corresponding joined image data may be retrieved by selecting an image joining mode from the operation panel of the MFP 10A (10B) and then reading the original document of the joined image data. In this case, once the joined image data is prepared, the original document can be used to extract the joined image data without again executing the operation for joining the images.

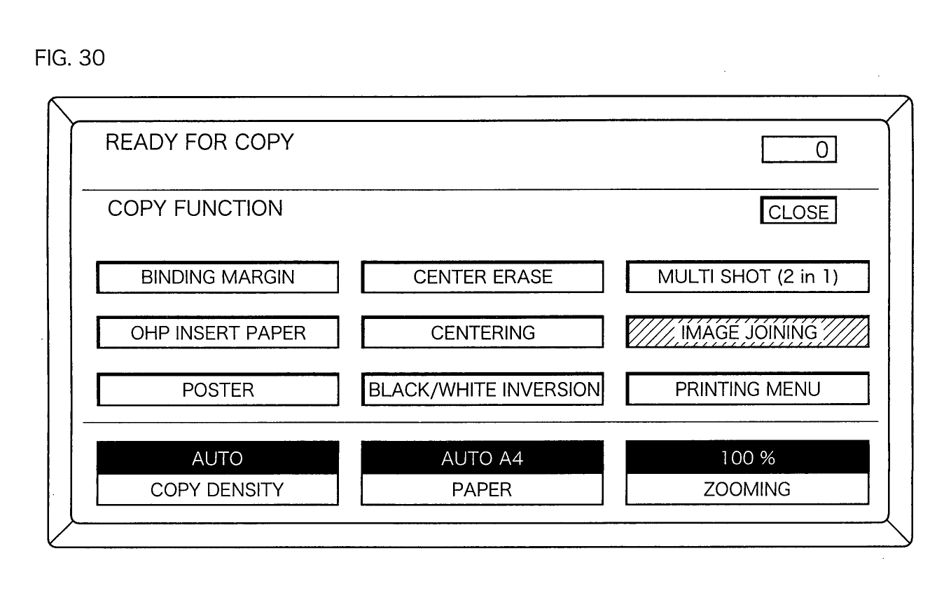

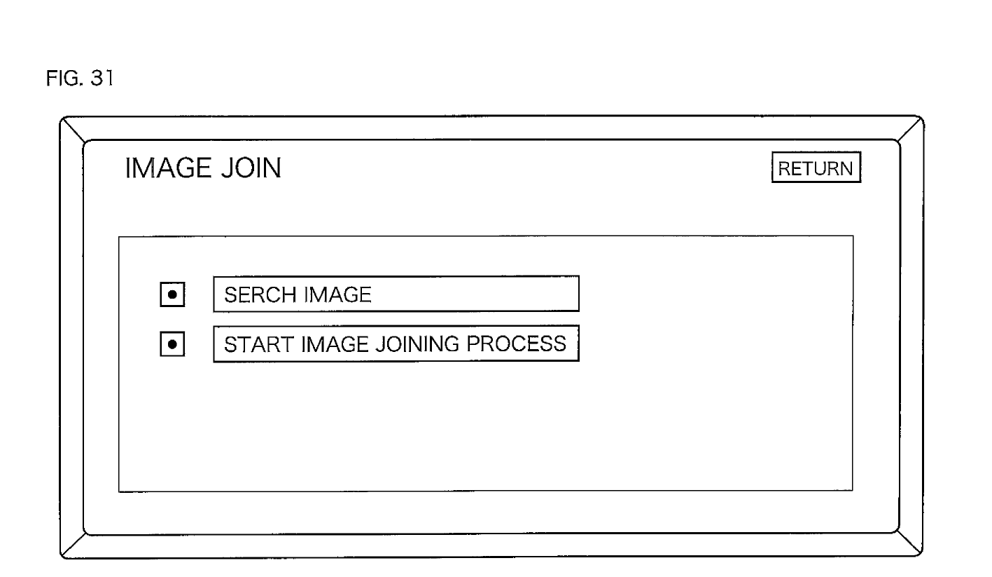

FIG. 30 is a diagrammatic view showing one example of the operation panel. FIG. 31 is a diagrammatic view showing one example of a screen that is displayed when the image joining mode is selected from the operation panel. The retrieval can be carried out by selecting the image joining mode from the operation panel shown in FIG. 30 and bringing the target down to the joining image data from the screen shown in FIG. 31. Thus, it is possible to quickly execute the retrieval and suppress the erroneous judgment. The original document is a part of the joined image. Hence, the threshold of the similarity judgment is set such that the joined image data can be extracted from the original document. For the threshold, the value from which the corresponding joined image data can be extracted may be determined by using the various documents. The joined image data may be stored after compressed by using the method corresponding to the kind of the document such as MMR, JPEG or the like.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within meters and bounds of the claims, or equivalence of such meters and bounds thereof are therefore intended to be embraced by the claims.

What is claimed is:

1. An image processing method of inputting two images having regions to be overlapped with each other and joining the inputted two images in said region, comprising the steps of:
extracting a plurality of connected components in which pixels are connected from each of said two images;
extracting feature points included in each connected component thus extracted;
calculating features of each image respectively based on the extracted feature points;
correlating the extracted feature points of one image with those of the other image by comparing the calculated features of each image;
calculating a transform matrix for transforming a coordinate system of one image into a coordinate system of the other image by using information of positions of the correlated feature points; and
joining said two images by using the calculated transform matrix and transforming said one image.

2. An image processing apparatus for inputting two images having regions to be overlapped with each other and joining the inputted two images in said region, comprising:
a connected component extracting section for extracting a plurality of connected component in which pixels are connected from each of said two images;
a feature point extracting section for extracting feature points included in each connected component thus extracted;
a features calculating section for calculating features of each image respectively based on the extracted feature points; and
an image join processing section capable of performing operations of:
correlating the extracted feature points of one image with those of the other image by comparing the calculated features of each image;
calculating a transform matrix for transforming a coordinate system of one image into a coordinate system of the other image by using information of positions of the correlated feature points; and
joining said two images by using the calculated transform matrix and transforming said one image.

3. The image processing apparatus according to claim 2, wherein said feature point extracting section removes feature points which become impediments when calculating the transform matrix, from said extracted feature points.

4. The image processing apparatus according to claim 2, further comprising a controlling section for storing the joined image as associating with features extracted from said two images, first identification information for identifying each of said two images and second identification information indicating the joined image.

5. The image processing apparatus according to claim 2, further comprising an document matching section for matching the inputted image with reference images;
wherein said document matching section contains said connected component extracting section, the feature point extracting section and the features calculating section and compares the calculated features with features of a pre-stored reference image and then votes for the reference image having coincident features.

6. The image processing apparatus according to claim 2, wherein said feature point extracting section calculates a centroid of the connected component extracted by said connected component extracting section and defines the calculated centroid as the feature point of the connected component.

7. The image processing apparatus according to claim 2, wherein said features are invariant parameters with respect to a geometrical change including a rotation, a parallel movement, a scaling of said image.

8. The image processing apparatus according to claim 2, wherein said features calculating section calculates a hash value in accordance with a hash function that is formulated by using a distance between the feature points extracted from one image, and defines the calculated hash value as the features of said image.

9. The image processing apparatus according to claim 2, wherein the region to be joined is preliminary determined for each image.

10. An image reading apparatus comprising:
a scanner platen on which a document is placed;
an image reading section for reading an image from the document placed on the scanner platen; and
the image processing apparatus according to claim 2;
wherein the two images read by the image reading section are joined by said image processing apparatus.

11. The image reading apparatus according to claim 10, wherein a region to be joined is set on said scanner platen.

12. An image forming apparatus comprising:
the image processing apparatus according to claim 2; and
an image forming section for forming the image, which is obtained by joining two images in the image processing apparatus, on a sheet.

13. The image forming apparatus according to claim 12, further comprising:
a scanner platen on which a document is placed; and
an image reading section for reading an image from the document placed on the scanner platen,
wherein a region to be joined is set on said scanner platen.

14. A recording medium storing thereon a computer program executable to perform the steps of:
extracting a plurality of connected components in which pixels are connected from each of two images having regions to be overlapped to each other;
extracting feature points included in each connected component thus extracted;
calculating features of each image respectively based on the extracted feature points;
correlating the extracted feature points of one image with those of the other image by comparing the calculated features of each image;
calculating a transform matrix for transforming a coordinate system of one image into a coordinate system of the other image by using information of positions of the correlated feature points; and
joining said two images by using the calculated transform matrix and transforming said one image.
